(19) United States
(12) Patent Application Publication
(10) Pub. No.: US 2024/0382042 A1
(43) Pub. Date: Nov. 21, 2024

(54) COOKING APPARATUS USING CAPACITOR SENSORS FOR IMPROVED PRODUCT QUALITY AND OIL USE EFFICIENCY

(71) Applicant: WINSTON INDUSTRIES, LLC, Louisville, KY (US)

(72) Inventors: Lloyd Dennis Hall, JR., Taylorsville, KY (US); Jonathan Winn Hall, Fisherville, KY (US); Kevin Paul Combs, Louisville, KY (US)

(21) Appl. No.: 18/641,315

(22) Filed: Apr. 19, 2024

Related U.S. Application Data
(60) Provisional application No. 63/460,453, filed on Apr. 19, 2023.

(51) Int. Cl. A47J 37/12

(52) U.S. Cl. CPC A47J 37/1266; A47J 37/1223; A47J 37/1261; A47J 37/128; A47J 37/1285

(57) ABSTRACT

An apparatus for cooking food under atmospheric or pressure environment or in a basket while immersed in a batch of cooking liquid. The cooking vessel is controllably heated and the level of the cooking liquid is controlled by at least one capacitor in contact electrical contact with a capacitor sensor in fluid communication with the cooking liquid and a controller for controlling the temperature and amount of cooking liquid in the cooking vessel at various stages of the cooking process.

### TECHNICAL FIELD

The invention relates to electronic liquid level sensors and, particularly, to a capacitive liquid level sensor or Acapacitor sensor@ that is functioning with a local microprocessor used as an apparatus for cooking food and more particularly, to an apparatus for deep fat frying food products and controlling the quantity and quality of oil used in the cooking process.

### BACKGROUND OF THE INVENTION

Cookers for deep fat frying of chicken and the like on a mass basis have developed into comparatively complex mechanisms requiring careful operation by trained personnel for best results as well as personnel safety. Furthermore, cooking oil requirements have proved to be a significant problem from cost and handling standpoints in terms of solids removal and oil replacement in the furtherance of efforts to provide a consistently good product that avoids digestive problems.

This invention relates to deep fat pressure frying of various foods and is particularly well suited for use in commercial establishments serving food products such as fried chicken, shrimp, frankfurters, hamburgers, potatoes or the like. For purposes of this discussion, chicken will be used as a exemplary food product with the understanding that the technology is applicable to any deep fried food product.

It has long been known that for optimum operation of this type of apparatus wherein particles of food, for example, breaded portions of chicken, tend to become mixed with the cooking liquid, some provisions must be made for clarifying such liquid and for keeping the particles from contact with heated surfaces which frequently are heated to 325 F. or higher. Furthermore, the particles themselves have utility for various purposes, such as a gravy stock, and should not be scorched or discolored.

Customarily, a filtration system as disclosed, for example in U.S. Pat. No. 3,466,997, or a removable collector unit such as indicated in U.S. Pat. No. 3,495,525, or some equivalent arrangement is employed to serve this purpose. However, the apparatus even when suitably equipped for keeping the body of cooking liquid in optimum condition must also provide for regulated heating of the liquid, and for safe release at appropriate stages of operation of the pressure which builds up in the apparatus. Typically, the used filtered oil must be replaced periodically to ensure quality of the food product cooked therein which is time consuming and expensive depending upon the quantity and quality of the used oil and cycles of use before each change. Many proposals have been advanced for the solution of these combined factors of safe operation, clarity of liquid and controlled heating, but have required relatively complex and expensive apparatus. It is a purpose of the present invention to overcome these problems by means of an improved apparatus characterized by its reliability of operation, safety, and adaptability to cooking various foods in a readily controlled manner.

### SUMMARY OF THE INVENTION

The present invention is for an apparatus and method for cooking food while immersed in a batch of cooking liquid controllably heated with the level of the cooking liquid controlled by at least one capacitor in electrical communication with a sensor in contact with the cooking liquid which is in electrical communication with a controller which may include a microprocessor for controlling the amount and temperature of cooking liquid in the cooking vessel. The apparatus provides a method for cooking food under pressure in a basket while immersed in a batch of cooling liquid includes a separable unit for collecting particles of food dropping from the basket, and for enhancing the useful life of the liquid and the edibility of the food. The cooking vessel is controllably heated and the apparatus is provided with a plurality of pressure relieving means for protection of the user.

This application discloses important aspects of the method disclosed in it=s U.S. Pat. Nos. 3,610,133 and 3,677, 170 which are incorporated by reference in their entirety.

The present invention provides a cooking apparatus and method of using comprising or consisting of an open-top non-pressurized vessel or an open top pressurized vessel having a bottom connecting to a side wall adapted to contain a replaceable batch of cooking liquid. In the present invention, incremental addition of new cooking oil eliminates most if not all of the total batch replacement of the used cooking oil. Included is means disposed within said vessel for rapidly heating the cooking liquid by direct contact therewith, a sealable cover for the vessel may be mounted adjacent an upper portion of the vessel with a removable collector unit supported within said vessel The unit contains a relatively cool and quiescent portion of said liquid, selectively operable drainage means for draining and filtering the batch of liquid from said vessel after each cook and replenishing used oil from a reservoir. A perforated basket is insertable into said vessel for holding food to be cooked. At least one capacitor sensor and preferably a plurality of capacitor sensors are attached at selected positions or disposed within the side wall of the vessel in contact with the cooking liquid for sensing the level of the liquid contained within said vessel together with temperature sensors and means for automatically releasing vapor from said vessel when a predetermined vapor pressure is reached therein. A programmable logic controller, microprocessor, or computer for interface with a user operator is in electrical communication with the capacitor sensors and means for controlling the level and flow rate and temperature of the cooking oil.

The invention comprises or consists of a cooking apparatus having a vessel operating under pressure and containing a batch of liquid fat which is heated by electrical coils in the vessel. The disclosure pertains to a deep fat fryer and a method of cooking food product using same in which the food product and cooking oil are employed in a ratio on the order of one to two, respectively, and are placed in a smooth walled generally cylindrical chamber of the vessel defined as a fryer with the fryer being provided with band type electric heaters adjacent to but spaced from the lower end of the chamber and outside of same that establish a convection flow in the cooking oil which rises adjacent the chamber wall and falls adjacent the mid portion of the chamber.

The cooking cycle is under control of a timer and the microprocessor, and safety means including both an automatically operable device and a manually operable device are provided for venting vapors from the cooking vessel.

A cover for the cooking vessel supports both a manually operable relief valve and an arrangement of structure for operating that valve and for preventing a sudden raising of the cover. The food product is applied to the chamber in a basket that seats on the chamber bottom above the special filter unit that also seats on the chamber bottom in a relatively cool area of the chamber. The chamber is closed by a cover hinge at one edge of the chamber and is clamped in place for cooking under pressure conditions. The cover hinge includes a lost motion arrangement so that when the cover clamping means is released, the cover seal is partially released so that fluids under pressure within the fryer escape in a direction away from the operator. An improvement of the present invention involves the use of recirculating the oil in that the fryer includes a drain at the bottom of its chamber through which the cooking oil may be periodically drained (preferably after each cook) under pressure through the filter unit to separate out the solids, after which the filtered cooking oil is returned to the chamber with enough new cooking oil to restore the original volume thereof. Associated with the cover is a pressure regulator that limits the pressure build up within the fryer, providing for both automatic and manual release of same, and directs release of fluids under pressure away from the operator.

Conventional cookers typically use one or more temperature sensors to detect the level of the oil in the cooker pot and the pot is filled or drained based on timers and the level of oil in the pot.

The capacitors in the present invention are more sensitive than the temperature sensors to control the level of the liquid cooking oil provides the capability of accurately accurate control of the level of cooking oil preventing flashing from heating elements coming on above the oil, and to insure the correct amount of oil is in the cooker, allowing re-circulation of used cooking oil filtered after each cook to be used with a requisite amount of new oil (to replace oil absorbed by the food product) to be added to the cooker eliminating and/or significantly reducing the necessity of replacing the entire batch of cooking oil periodically.

A filter tank unit is attached to the lower end of the cooking vessel in open communication therewith and retains food particles dropping from the vessel. The liquid in the collector unit is relatively quiescent and cool and being out of the path of convection currents permits the loose food particles to be segregated from the main body of liquid which thus remains in a more clarified condition with resulting improvement in the taste of the cooked food.

The deep fat cooking chamber and heating arrangement avoids charring of solids, to provide a cooking oil drainage arrangement filter unit therefor that permits periodic filtering and re-use of the cooking oil, to provide a safety cover arrangement that protects the operator and makes for easy pressure regulation, and to provide a deep fat fryer that is economical to manufacture, convenient and efficient in use, and long lived in operation.

In one preferred embodiment, deep fat frying of the chicken food product is done on the basis of one pound of chicken to about two pounds of cooking oil or fat, with the oil being first preheated to about 375 degrees F. under atmospheric conditions, during the course of which the heat is turned off, the chicken then being deposited in the fryer and cooked with the cover open until it is browned to a cornflake color, whereupon the fryer is sealed for pressure cooking for about 12 minutes, during which period the temperature of the cooking oil drops to about 250 degrees F., and no additional heat is applied until the last few minutes (if necessary). The resulting high-quality product is removed from the cooking chamber for serving or temporary storage, and another batch of chicken may be applied to the fryer in the same cooking oil, whereupon the cooking procedure is repeated. The cooking oil is periodically drained through a special filter unit under pressure, which removes the solids from the cooking oil, and then is reapplied to the fryer together with sufficient make-up cooking oil to restore the cooking oil to its original volume. Additional batches are prepared in like manner using the same cooking oil or fat charge, cleaned, and replenished as indicated. The cooking oil is subjected to testing to ensure that the cooking oil has not broken down. A selected amount of new cooking oil charge can be charged to each new cook as needed to continually replace the cooking oil, minimizing degradation and the necessity of shutting down the cooker to drain and replace the cooking oil.

One of the major costs of cooking fried products such as chicken is the cost of cooking oil. In conventional cookers using the time and temperature control methods, the old used oil is pumped out and replaced every 30-60 days. With the present invention, draining, filtering and replacing the oil with every cook, the oil is constantly replenished, and the quality of the oil will consistently pass the free fatty acid test, total polar compounds test, and visual test without replacement. The oil is filtered after every cook and replenished with new oil to compensate for the small amount of oil that is absorbed by the product with each cook. The method is more efficient and reduces labor and safer than the conventional time and temperature fill methods.

The instant invention drains the oil down in-between cooks and the oil is filtered after every cook. It is important leave the heaters turned off until covered by the oil in order to prevent flash fires, so the capacitor sensors of the present invention provides a reliable method to sense when oil is over the heaters.

The pot capacitor sensors each have a very specific purpose. The two bottom capacitors sensors are dualistic and positioned at the same level vertically on the pot for safety in order to confirm the level or oil and confirm same with a second capacitor sensor working off capacitance. If an object like a brush or edge of the basket touches one of the capacitor sensors it would activate an alarm or warning because it working off capacitance; however, since two capacitor sensors are used to provide duplicate results, the capacitor sensor would note the contact but an alarm would not go off or trigger a reaction in the fill cycle because both capacitor sensors would not be touched at same time resulting in a false trigger. When capacitor sensors 104, 106, 108 establish when oil is back up to proper level the operator can drop more chicken in the pot. Prior to the instant invention utilizing capacitor sensors, the operator was required to check the fill level to confirm proper oil level.

Competitors conventional cookers use temperature to check hot oil level, so temperature drops serve as the indicator, temperature sensor are installed in the pot and in contact with the cooking oil or the temperature sensors are in electric or conductive communication with a piece of metal touching the cooking oil in the pot.

In the present invention, the capacitor sensors have contacts exposed on the sidewalls of the cooker pot and the capacitors are in electrical communication via wire or electronic signals of the amount or change of capacitance upon contact with fluid that is fed to a circuit board which manages the fill fluid levels and pumps and valves and records and displays the results on a screen with values for capacitance changes.

It is not safe to operate the cooker with oil above the fill level. The instant invention uses a triangle pattern of capacitor sensors wherein the (top triangle) of capacitor sensors which are activated upon contact of the oil to whereby when the level of the oil reaches an overfill line or point, the vessel will drain the oil to an appropriate level. A display will indicate ARelevel-Overfill Protection@triggered, resetting oil levels.

The present invention also includes turbulence detection. As the product is constantly taking oil out of cooker vessel upon completion of cooking, an oil storage tank in fluid communication with a main pump will pump oil from a reservoir to refill the cooker. The oil reservoir is refilled from a storage tank when the main pump sucks air. If filling the cooker creates turbulence in the oil and the capacitor sensor detects a difference in the temperature of the oil, a small pump will refill and top off the reservoir from the storage tank. When the capacitor sensor indicates a threshold has been reached for a selected level a selected number of times, the oil is pumped into the cooker based on a pre-set time.

Filters used in the invention may become clogged resulting in a false indication of the level of oil for a given time, leaving operators with the task of trying to determine why the oil level is not filling to the correct level within the designated time. In the instant invention, the motor and pump set on top of the filter. The pump will turn on the oil as required based on the oil level data from the capacitors or the operator can turn on the heaters and the cooker software will set up the oil fill for the operator. The present invention drain the oil form the cooker on every fill. Because the oil is drained out after every cook, the capacitor sensor changes and shows it has been exposed to the atmosphere so it recalibrates. A pump is used to pump the oil from the cooker through the filter after each cook, so the cooker cleans oil each time the oil is drained after each cook.

It is an object of this invention is to provide an apparatus for cooking food products which not only provide a consistently good product under low pressure conditions, but which also provides multiple uses of the same cooking oil charge without adversely affecting quality of the cooked product.

It is an object of the present invention to provide a means for measuring the quantity of cooking oil before and after cooking each batch of food maintaining a predetermined level by adding new oil to each batch as needed.

It is another object of the invention is to provide a deep fat fryer that is safe and easy to operate by unskilled workers.

It is another object to reduce the steps of cooking food products to a few simple steps which will consistently provide a high-quality product.

It is an object to utilize capacitor sensors which are more sensitive than temperature sensors to allow the liquid level to be controlled more accurately to prevent flashing of the oil from heating elements coming on above the oil before it reaches the correct fluid level.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a perspective view of a pressure cooking apparatus for frying food in oil with the cooker cover mounted for pivotal movement and showing a display on the front and drawers for holding accessing the oil reservoir and filter and casters of the apparatus;

FIG. 2 is a front view of FIG. 1 showing the display panel, open top, oil reservoir and filter drawers at the bottom and casters;

FIG. 3 is a front sectional view of FIG. 1 with the cabinet panels removed showing the capacitor level sensors, heating coils or bands, motor, oil filter, oil reservoir, filter, and closed cover with handles;

FIG. 4 is a front sectional view of FIG. 1 showing the capacitor level sensors, heating coils or bands, motor, oil filter, oil reservoir and drain, filter, closed cover with handles, and casters;

FIG. 5 is a right-side view of FIG. 1 showing the pressure cooking apparatus showing the open lid cover and latch, instrument panel, and casters;

FIG. 6 is a sectional right side view of FIG. 1 with the side panel removed showing the pressure cooking vessel, closed cover, capacitor sensors, instrument display, pumps, filter, oil reservoir and lines;

FIG. 7 is a sectional right-side view of FIG. 1 showing the pressure cooking vessel, open lid cover, heating coils, capacitor sensors, oil pumps, instruments, filter, and oil reservoir;

FIG. 8 is a top view of FIG. 1 showing the open lid cover, and top of the cooking vessel, heating coils and drain;

FIG. 9 is a top view of the cooking vessel of FIG. 1 showing the heating coils mounting to the interior side walls of the cooking vessel and showing the capacitor sensors for detecting the level of oil in the vessel with level indicators on the inner surface of the cooking vessel;

FIG. 10 is a side view of a capacitor sensor used with the cooking apparatus of FIG. 1 showing the sensor connector, conducting insulator, and sensor extending from the cooking vessel wall.

FIG. 11 is a perspective exploded view of the connector end and pot end for a capacitor sensor for the apparatus of FIG. 1;

FIG. 12 is a cutaway view showing the capacitor sensor disposed in the side wall of the cooking vessel of the apparatus of FIG. 1;

FIG. 13 is a close-up perspective view showing the heating bands and capacitor sensors of the apparatus of FIG. 1;

FIG. 14 is a perspective view showing the filter drawer for the oil reservoir; and

FIG. 15 is a perspective view of the filter pad on the screen of the cooking apparatus of FIG. 1.

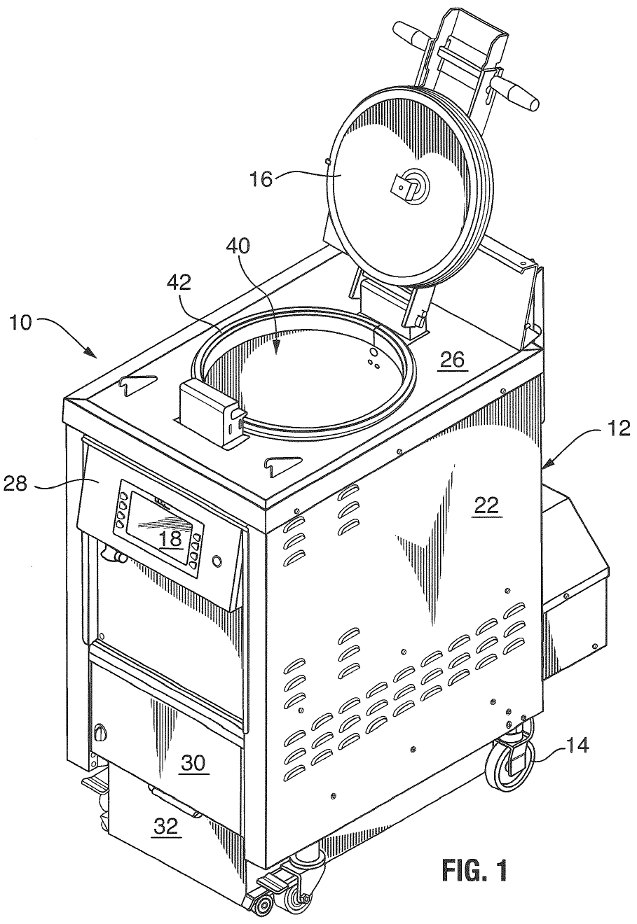

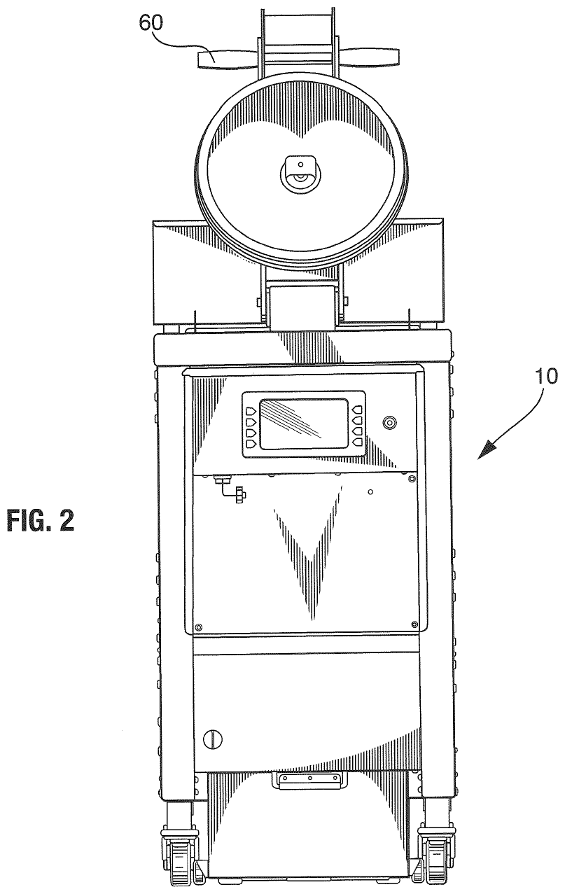

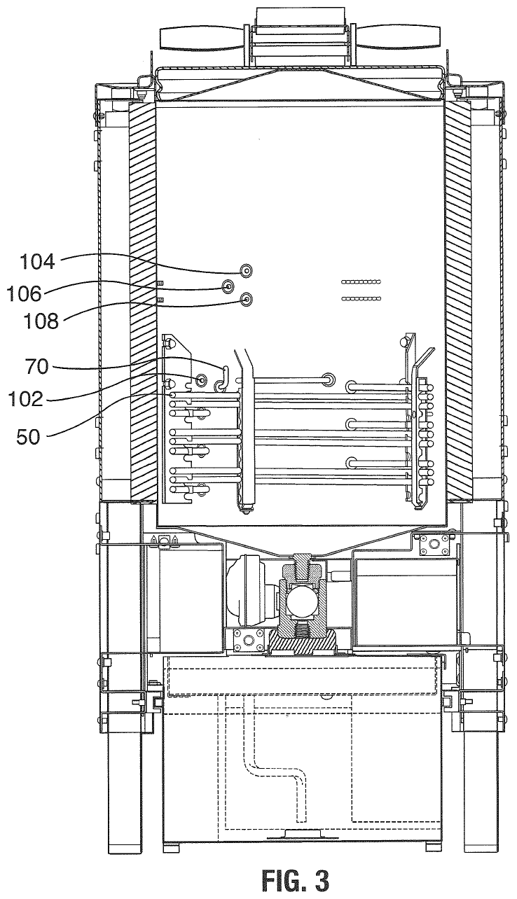

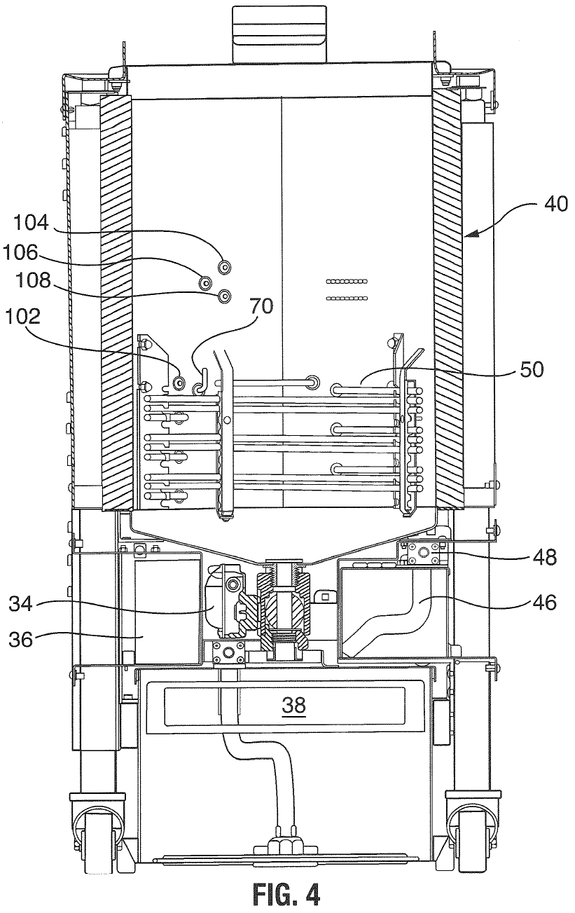

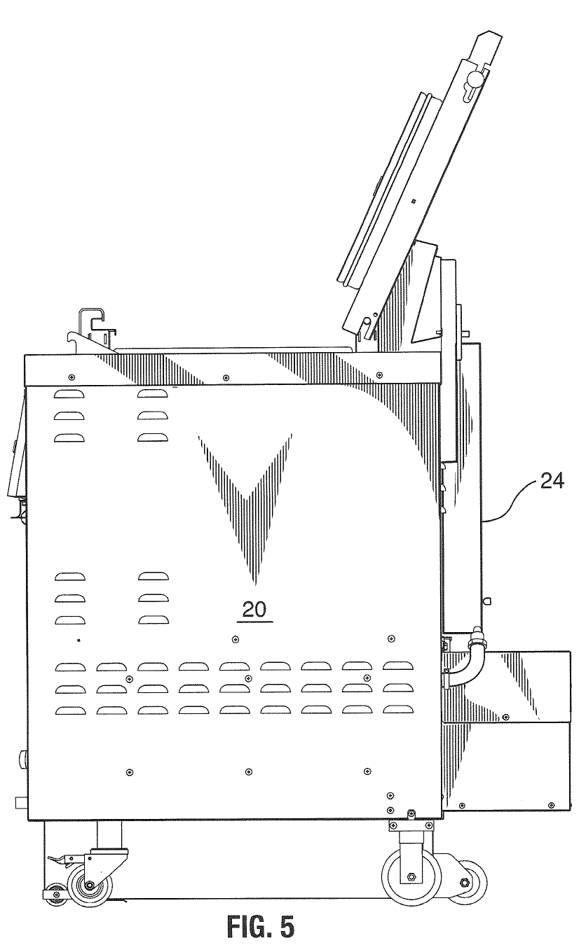

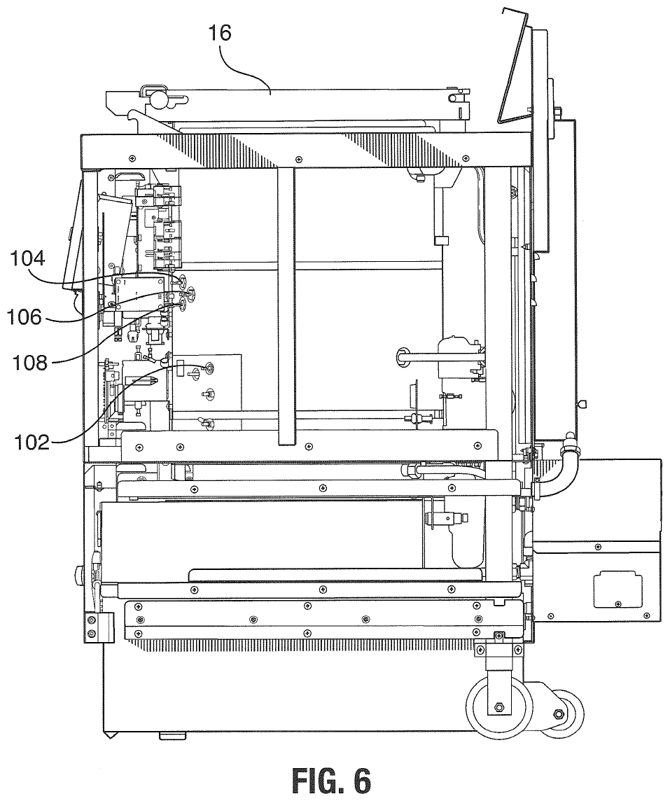

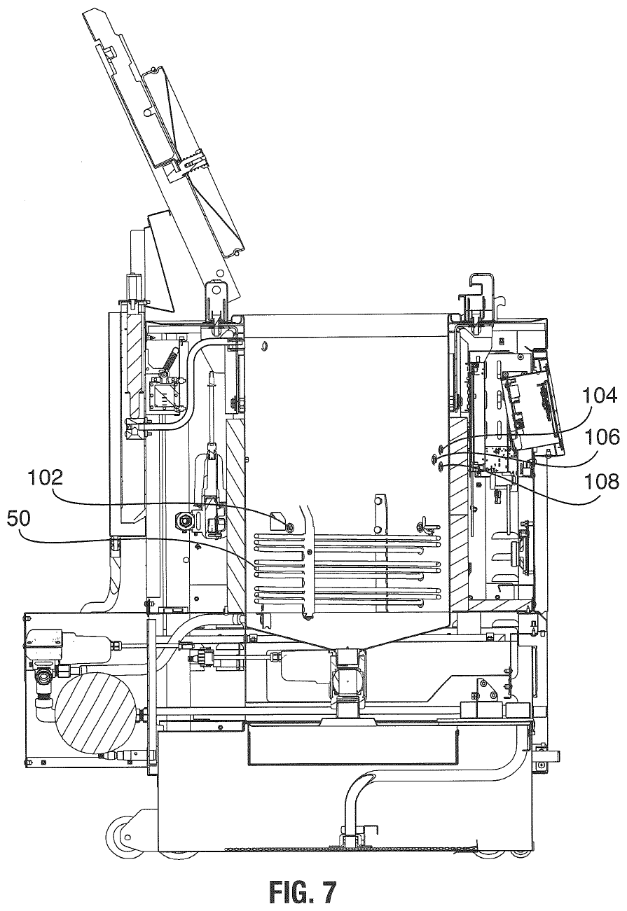

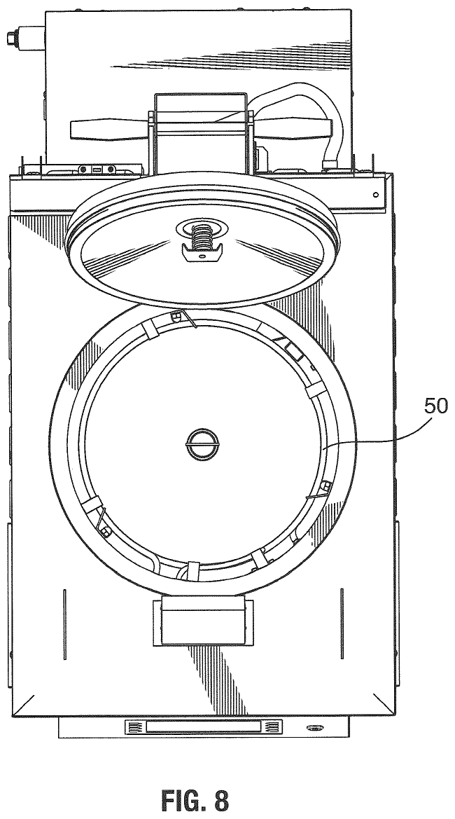

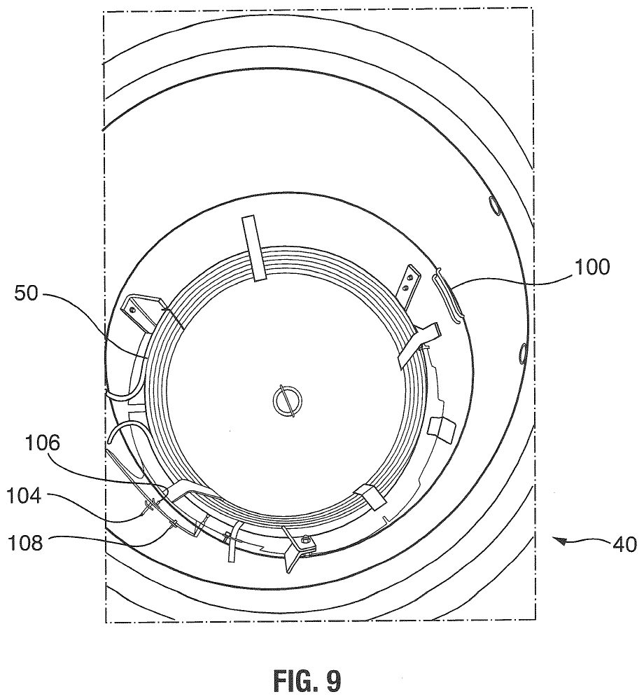

### DETAILED DESCRIPTION OF THE PREFERRED EMBODIMENT

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term Aabout@ can be reasonably appreciated by a person skilled in the art to denote somewhat above or somewhat below the stated numerical value, to within a range of ±10%.

The product to be cooked in the present invention could be various types of vegetables, grains, or meat such as pork, beef, chicken, or other food product. As an example, the cooking of chicken will be described as an exemplary example.

The information included in this section, data or specifications, including any references cited herein and any description or discussion thereof, is included for exemplary purpose only and is not to be regarded as subject matter by which the scope of the invention as defined in the claims appended hereto is to be bound.

The following text sets forth a broad description of numerous different embodiments of present disclosure. The description is to be constructed as exemplary only and dose not describes every possible embodiment since describing every possible embodiment would be impractical if not impossible. It will be understood that any feature, characteristic, component, composition, ingredient, product, step or methodology described herein can be deleted, combined with or substituted for, in whole or part, any other feature, characteristic, composition, ingredient, product, step or methodology described herein. Numerous alternative embodiments could be implemented, using either current technology or technology developed after the disclosure date of the invention.

The description of the exemplary embodiments according to principles or spirits of the present invention is intended to be read in connection with the accompanying drawings, which are to be regarded as part of the entire written description. In the description of the embodiments of the invention disclosed herein, for describing precisely and concisely, each element in the drawings is assigned a reference number in most cases in term of its feature corresponding the claims append unless expressly described otherwise.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention comprises or consists of a cooking apparatus 10 and method of using capacitor sensors to measure the liquid level of the cooking oil providing means to more efficiently control the cooking process and use of cooking oil as opposed to conventional control means based only on cooking time and temperature. Capacitor sensors are more sensitive than the temperature sensors and provide more accurate control of the level of cooking oil preventing flashing from heating elements coming on above the oil, and to insure the correct amount of oil is in the cooker, allowing re-circulation of used cooking oil filtered after each cook to be used with a requisite amount of new oil (to replace oil absorbed by the food product) to be added to the cooker eliminating and/or significantly reducing the necessity of replacing the entire batch of cooking oil periodically.

The capacitor sensors and control process can be implemented on different types of hot oil-based cookers including both pressurized and non-pressurized cooking vessels.

In the present invention, incremental addition of new cooking oil eliminates most if not all of the total batch replacement of the used cooking oil. Included is means disposed within said vessel for rapidly heating the cooking liquid by direct contact therewith, a sealable cover for the vessel may be mounted adjacent an upper portion of the vessel with a removable collector unit supported within said vessel The unit contains a relatively cool and quiescent portion of said liquid, selectively operable drainage means for draining and filtering the batch of liquid from said vessel after each cook and replenishing used oil from a reservoir. A perforated basket is insertable into said vessel for holding food to be cooked. At least one capacitor sensor and preferably a plurality of capacitor sensors are attached at selected positions or disposed within the side wall of the vessel in contact with the cooking liquid for sensing the level of the liquid contained within said vessel together with at least one temperature probe 70 and means for automatically releasing vapor from said vessel when a predetermined vapor pressure is reached therein. A programmable logic controller, microprocessor, or computer for interface with a user operator is in electrical communication with the capacitor sensors and means for controlling the level and flow rate and temperature of the cooking oil.

A typical deep fry cooking vessel consists of comprises an open-top non-pressurized vessel or an open top pressurized vessel having a bottom connecting to a side wall adapted to contain a replaceable batch of cooking liquid.

In one preferred embodiment, a cabinet 12 surrounding a frame is mounted on wheels 14 and includes a generally flat top having a central opening closed by a hinged cover 16. Electrical elements are suitably housed in a selected location on the unit with a display and user interface panel 18 in the front of the unit. A left side wall 20, right side wall 22, and a rear wall 24 are attached to the top 26 and an upper front panel 28 is attached to the same cabinet top. In the front of the unit, below the cooking vessel, a plurality of sliding drawers 30, 32 are provided for ready access to the pumps 34 and oil reservoir 36 and filter collector unit 38. A cylindrical metallic vessel defining a cooking pot Acooking vessel@40 sometimes referred to as a Afryer: has an upper rim 44 with an undercut shoulder resting on the top and attached thereto as by means for fastening extends downwardly within the cabinet. The lower wall portion of the vessel may include an annular boss on the outer periphery of which a slot is formed for retention of an O-ring seal. A conduit 46 extends from a drain collector unit 48 mounted near the lower side of wall portion.

The cooking vessel 40 is formed with a shoulder on its inner periphery near the rim and a tubular perforated sleeve having a flange engageable on that shoulder for removable positioning within the vessel. A vapor exhaust coupling may be mounted within the vessel sidewall 41 and has an upwardly directed standpipe extending through an aperture in the flange of the sleeve and terminating adjacent the undersurface of cover when the cover is closed. Mounted on the inner surface of the vessel below the normal liquid level is a group of heating bands or heating coils 50 and a plurality of capacitance sensors Acapacitor sensors@102, 104, 106 at selected positions and levels along the inner wall of the cooking vessel in liquid communication with fluid filling the vessel. In one preferred embodiment, a perforated basket for containing food to be cooked includes a handle 60 and supporting rods projecting laterally from the handle. A sleeve may be used to protect the heating coils 50 from being struck by the basket and serves to shield the coils from being clogged with food particles. dropping from the basket (not shown), and aids in the convection flow of cooking liquid.

A manually operable relief valve actuator can be included. A conventional relief valve can be biased to closed position. The pressure within the vessel may be vented at any time during operation, but preferably only at the end of a cooking operation. The valve may direct all fluid pressure discharged from the vessel through the valve rearwardly of the cabinet and away from the position where the operator would normally stand.

An adjustable timer may be mounted on the plate and may be of the manually preset for selected functions; however, a novel feature of the present invention is the use of capacitor sensors to control the level of the cooking fluid or cooking oil within the vessel, and the draining and filling thereof. The capacitor sensors are more sensitive than conventional temperature sensors and allow the liquid level to be controlled accurately preventing flashing from heating elements coming on above the oil in order to ensure the correct amount of oil is in the cooker.

Relays controlled by the microprocessor and a terminal board are mounted on the rear of plate and a light is visible on the front of instrument panel to indicate when current is being supplied to the heating coils or the pumps and indicate when transfer switches are being activated as well as the temperature and level of the oil at various positions within the vessel, oil reservoir and storage tank.

The cabinet includes a touch screen 18 control surface and/or an operating panel surface that includes a microprocessor and touchscreen that serves as an off-on switch and a means of controlling the amount of heat supplied by the heater device, which is in the form of a plurality (preferably three) of band type heating 50 devices operably associated with relays and the microprocessor, the touch screen indicates the selected warm up or high heat supply cooking range position in accordance with the heat supply requirements that are indicated hereinafter. The touch screen also shows the temperature increase and decrease in increments and is programmable for start, stop, and change in temperature. The panel also includes two way off-on switch device which is incorporated together with the microprocessor and relays to control the heating band devices to a suitable source of power in one position of switch, while shutting off the source of power in the opposed position there. The control instrument panel also includes an indicator light indicated wired to light when the heater device is electrically actuated. The circuiting employed for the heater device is made via the relays with the microprocessor and programming with the touch screen.

The cabinet is provided with a container or reservoir 36 into which cooking oil from the vessel or pot 40 is drained after a cook. The cooking oil is drained under pressure through filter unit accessible through a bottom drawer 51 having replaceable filter pads (typically paper or polymeric material) which fit on a removable screen 52 within a tray 54 allowing the oil to flow therethrough for re-use.

Cooking pressure is regulated by a pressure block with a hole drilled into it in the back of the cooker and a solenoid is activated when pressure is desired during the cooking process. The solenoid pulls a weight into the hole in the block and only when the desired pressure is reached is the steam powerful enough to push up on the block to bleed off excessive pressure. Pulling down of the weight and building up of steam pressure from the food pushing back regulates the pressure at from between 11-15 psig.

In accordance with one preferred embodiment of this invention, the vessel and basket unit are proportioned such that the food product, for example chicken, is divided into the customary cooking segments, and cooked in a suitable cooking oil or fat contained within chamber in the ratio of one pound of chicken to about two pounds of cooking oil. In the specific embodiment illustrated, the vessel and basket unit are designed such that when the basket is fully loaded, about ten pounds of chicken will be cooked in about twenty-one pounds of cooking oil, with the vessel being about 60 percent full when only the cooking oil is contained in same. These specifications will vary according to the design of the cooker.

### METHOD OF OPERATION

The instant invention drains the oil down in-between cooks and the oil is filtered after every cook. It is important leave the heaters turned off until covered by the oil in order to prevent flash fires, so the capacitor sensors of the present invention provides a reliable method to sense when oil is over the heaters.

The capacitor sensor 102 senses the level of the oil when the cooking is fulling after a cook to confirm the liquid level has reached a level over the top heating coil so that the heating coil can be turned on to start heating the oil even while the cooking vessel is fulling. As noted previously, the capacitor sensor allows the liquid level to be controlled accurately preventing flashing from heating elements coming on above the oil. The step decreases cycle time and increases the batch time efficiency.

The capacitor sensors 104, 106, 108 in the cooking vessel each have a very specific purpose. The two bottom sensors are dualistic and positioned at the same level vertically on the pot for safety in order to confirm the level or oil and confirm same with a second sensor working off capacitance. If an object like a brush or edge of the basket touches one of the sensors it would activate an alarm or warning because it working off capacitance; however, since two sensors are used to provide duplicate results, the sensor would note the contact but an alarm would not go off or trigger a reaction in the fill cycle because both capacitor sensors would not be touched at same time resulting in a false trigger. When capacitor sensors 104, 106, 108 establish when oil is back up to proper level the operator can drop more chicken in the pot. Prior to the instant invention utilizing capacitor sensors, the operator was required to check the fill level to confirm proper oil level. Fill level lines 100 are still shown by indentions or raised dimples or creases on the inner wall of the cooker for the convenience of the operator.

Competitors conventional cookers use temperature sensors and a thermostat to check and control hot oil temperature, so temperature drops serve as the indicator, so temperature sensor are installed in the pot and are in contact with the cooking oil or the temperature sensors are in electric or conductive communication with a piece of metal touching the cooking oil in the pot.

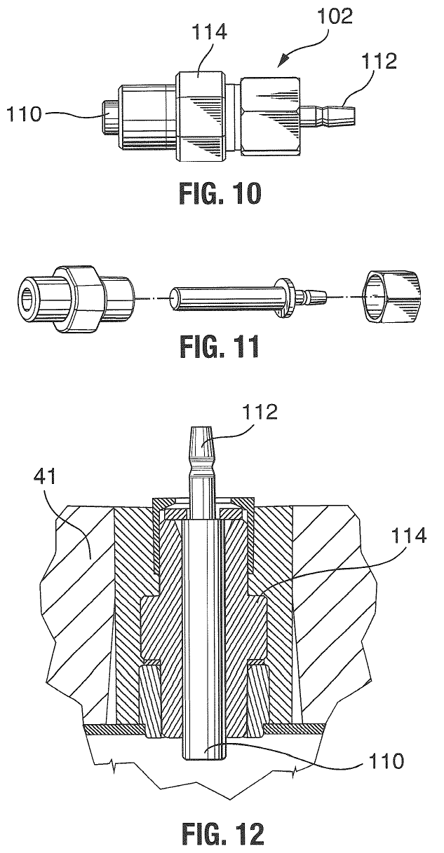

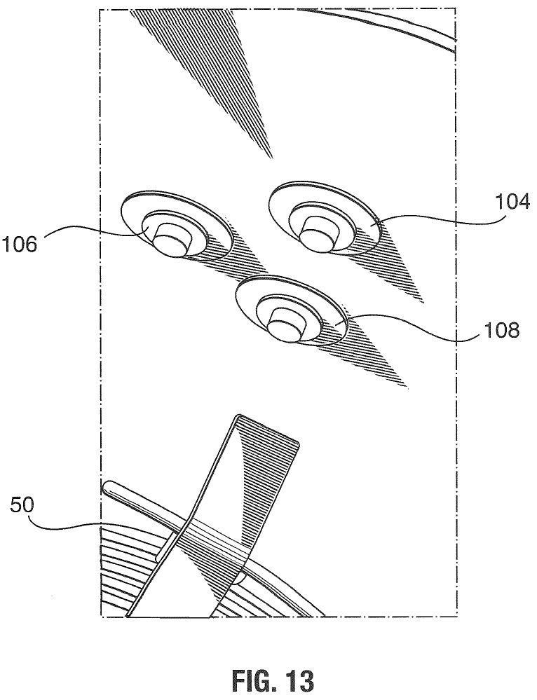

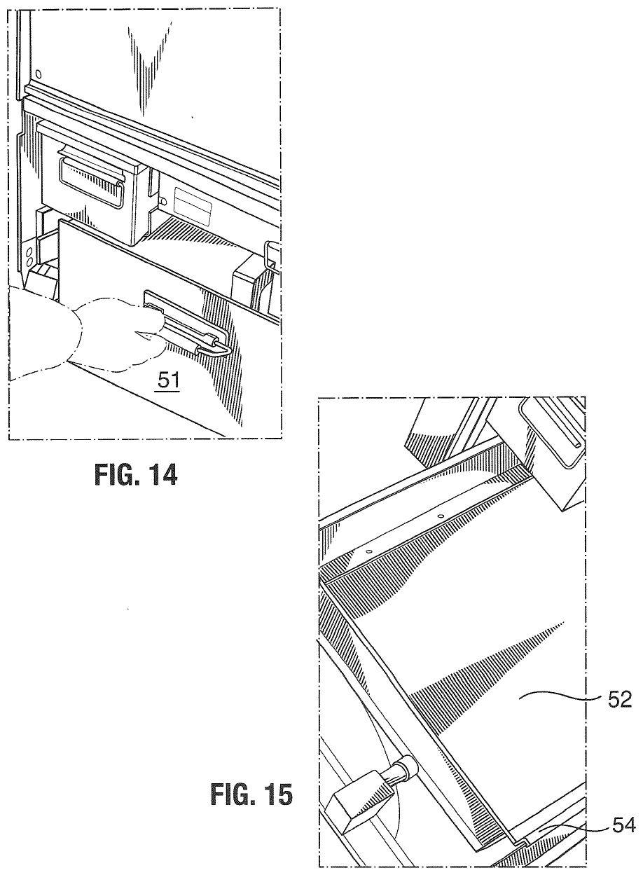

As best shown in FIGS. 10-12, the capacitor sensors 102, 104, 106, and 108 have contacts 110 exposed on the sidewalls of the cooker pot and the capacitors are in electrical communication via wire or electronic signals of the amount or change of capacitance is fed to a circuit board and microprocessor which manages the fill fluid levels and pumps and valves and records and displays the results on a screen with values for capacitance changes. The capacitor sensor 102 includes a sensor connection 112, conducting insulator 114, and contact 110 which is exposed to the liquid on the inside wall of the cooker vessel. A cutaway view in FIG. 12 shows a capacitor sensor deposed in the cooker sidewall.

It is not safe to operate with oil above fill level. The instant invention uses a triangle pattern of capacitor sensors wherein the (top triangle) of sensors 104, 106, and 108 which upon activation by contact of the oil will trip an overfill line and the cooking pot of the fryer will drain to appropriate level. A display will indicate ARelevel-Overfill Protection@triggered, resetting oil levels.

The present invention also includes turbulence detection. As the product is constantly taking oil out of fryer upon completion of cooking, an oil storage tank in fluid communication with a main pump pumps oil from a reservoir which is refilled from a storage tank when the main pump sucks air. When the filling pot creates turbulence in the oil and capacitance sensors detects difference in temperature, a small pump will refill and top off the reservoir from the storage tank.

When the capacitors indicates a threshold has been for the level a selected number of times, then the oil is pumped based on time, for example, two minutes to fill if the pot is not filled to the proper level by pumps from the reservoir, but the time sensors are deemed less dependable because timers and variables are different for different equipment.

Filters used in the invention may become clogged resulting in a false indication of the level of oil, leaving operators with the task of trying to determine why the oil level is not filling to the correct level within the designated time. In the present invention, the motor and pump set on top of the filter. The pump will turn on the oil as required based on the oil level data from the capacitors or the operator can turn on the heaters and the cooker software will set up the oil fill for the operator. The oil is drained after each cook and filtered and reused for the next cook. Because the oil is drained out after every cook, the capacitor sensor changes and shows it has been exposed to the atmosphere, so it recalibrates. A pump is used to pump the oil from the cooker out and through the filter, so the cooker cleans oil each time the oil is drained after each cook.

In different regions of the country the preference for taste, crispness, color and other characteristics of the cooked product may vary. Having filled the cleaned vessel and its attached collector unit to the proper level with cooking oil using the capacitor sensors to ascertain the proper level of oil, the oil is first heated to the temperature, for example 375° F., determined to be the most desirable temperature at the time when the uncooked chicken is loaded into the apparatus. Heat is controlled by the microprocessor and the relays providing power to the heating elements to reach a temperature of at a selected setting such as for example 375° F. and the timer is set to the recover position. At this position of the timer, the closed switch permits power to be supplied through microprocessor and relay. The relay therefore has its contacts closed to supply power to heaters and instrument panels. When the temperature of the oil reaches the prescribed value, a bulb senses that temperature and causes the switch to open cutting off the power to the heaters. The instrument panel alerts the operator when the oil has reached a desired cooking temperature, and the prepared chicken pieces are then dropped into the basket piece by piece to seal each surface of the chicken pieces before they are laid in contact with each other. The collector unit is functioning during this period to collect any fragments of breading or the like which are dislodged into the heated liquid. The lid is closed and latched, and a timer is set to the desired cooking time, for example, 11 minutes. Thus, at the selected time, the microprocessor is set by the control panel to prevent the heaters from being re-energized. The pressure within the vessel is held to a predetermined maximum value, for example 14 psig (pounds per square inch), under the influence of the described weight assembly. The pressure value is determined by cooking and by safety considerations. During this cooking period the temperature of the chicken will rise and boiling of moisture contained in the chicken will occur at the surface of the chicken. The resulting steam will be held in the vessel until the weight assembly is lifted by that internal pressure and which pressure will be held constant in the vessel throughout the remainder of the cooking cycle.

It will be appreciated that the boiling of moisture from the chicken will now have dropped the temperature of the liquid oil to the point where the heaters increase heating the excess fats driving it out of the chicken and crispness of the cooked product is obtained. The internal pressure within the cooking vessel to be exhausted automatically. At this time the cooking will have been completed and the described handle on the cover can be manually activated to further exhaust the pressure preparatory to opening the cover of the vessel. The cooked chicken is then lifted out in the basket and placed on a suitable tray, and the basket replaced.

At the termination of the cooking cycle, the oil is drained from the vessel and circulated through a filter and stored in a reservoir. Accordingly, as the cooked chicken of a completed cycle is being removed from the apparatus and while the timer is resting in its recover position the heaters are returning the cooking liquid to 375° F. temperature in readiness for the next cooking cycle. About five minutes of time will generally be sufficient for this heat recovery.

While cooking the band heaters heat up and supply heat to the vessel and through its wall to heat up the oil until the selected temperature of the oil is obtained, which for these examples is approximately 375° F., whereupon microprocessor operates to shut off the heating device, as will be indicated by the turning off of indicator lamp. The arrangement is preferably such that there will be sufficient heat radiating and being conducted from heater device so that the cooking oil will heat up to about 375 degrees F.

The positioning of the heater device adjacent the lower portion of vessel and about same establishes the annular convection current flow pattern in the heating oil, wherein hotter cooking oil adjacent the surface of vessel raises upwardly and at the top of the vessel moves toward the center of same where it tends to move downwardly toward filter device and then toward the vessel surface for reheating.

Assuming that a basket has been loaded with the chicken to be cooked, the basket is grasped by grasping its handle and is lowered into the vessel ‘(with its handle ends retracted into the basket), to the position where its legs rest on the bottom of the vessel with the cover remaining open; the chicken is cooked for several minutes until it has a color similar to that of cornflakes, as can be determined by visual observation (as by temporarily removing one or two pieces for inspection purposes). The cover is then swung to its initial closed position. The hand operating dial of timer mechanism is set to allow about a 12 minute operating time before the timer mechanism operates the regulator to release the pressure build up within vessel. Thereafter, the cooking of the chicken proceeds, the moisture from the chicken parts creating steam pressure to place the vessel in the desired pressurized condition. As a result of the chicken and basket being put into the fryer, the temperature of the oil will quickly drop to about 300 degrees F., but the residual heat in the device and the vessel wall is such that cooking proceeds through the browning and pressure cooking stages without having to supply more heat until the last few minutes of the cooking period set by operation of timer, heat is supplied by the microprocessor through the relays to turn heater device on as needed. In practice, the temperature of the cooking oil drops down to about 250 degrees F. during this cooking period. The heating oil convection flow pattern continues, though substantially modified by the presence of the basket and chicken within vessel.

After the time interval that has been set on the timer has elapsed, the pressure regulator operates to release the pressure within the vessel through valve, the sound of which will alert the operator that it is now time to open the cover. After draining, the basket may be removed to remove the chicken therefrom for refilling. A new load of chicken parts may then be applied to and cooked in the fryer in the manner indicated by recycling and reheating the cooking fat. The heater device heats the cooking oil up to 375 degrees F., as before, and prior to application of the fresh chicken into vessel.

The arrangement of this invention is such that a number of batches of chicken may be consecutively cooked in the same cooking oil without changing the cooking oil, and even when this is done, the oil is merely filtered and then returned to the vessel with sufficient make-up oil to restore the original volume to the chicken versus cooking oil ratio that has been previously indicated.

The smooth contour of vessel wall and the lack of any recesses or projections into the chamber leaves no places for solids to become lodged so that they will char, and the operation of the fryer is such that the cooking oil is not subject to high heat for any longer than necessary, which avoids premature break down of the oil. Furthermore, the convection flow pattern of the oil during the heat up period tends to move solids toward the cooler central portion of the oil charge so that they will tend to drop onto the filter device and thus settle out of the hotter oil in which the cooking is done, whereby charring of solids is materially avoided. As experience has shown that for deep fat cooking from the standpoint of taste, appearance and digestibility the fatty acid content should be maintained in the (0.13 to 0.27) percent by volume range, and charring of food solids is known to significantly increase the fatty acid content of cooking oils, the minimizing of charring achieved by this invention is an important factor in permitting repeated use of the same cooking oil without adversely affecting the quality of the cooked product.

Conventional fryers provided six batches of chicken could be safely cooked in the same cooking oil in terms of providing a high quality product that is free of digestive problems. After the six batches of chicken, the cooking oil would be filtered. A novel feature of the instant invention is that the cooking oil is drained and filtered after each cook with any used oil being replenished so it is possible to operate without ever changing the cooking oil because the cooking oil remains above the requisite quality level by replenishing the used oil with fresh oil prior to each cook.

In the present invention, the oil is filtered, recycled and replenished with fresh oil in each cooking cycle. More efficient use of the cooking oil is achieved because the capacitor sensors are more sensitive than conventional sensors used to control the oil level and allow the liquid level to be controlled accurately preventing flashing from heating elements coming on above the oil in order to ensure the correct amount of oil is in the cooker.

When draining the oil, the compressor motor provides air under pressure supplied to the sealed off vessel up to the point where it starts escaping through regulator. The operator then opens the valve permitting the pressure within vessel to force the cooking oil therein through the filter unit and out through port or drain opening and into the cooker reservoir. The filtering of the oil through filter unit under the high-pressure conditions indicated effects a drying of the solids collecting on top of the filter unit, which makes for ready and easy removal of same from the fryer by applying the hooked end of a suitable implement to the handle of the filter device to remove the filtered out solids and filter unit as a whole from the vessel.

The filter unit may be cleaned off periodically and replaced within the unit whereupon the filtered cooking fat may be returned to the vessel and supplemented by new cooking fat up to the original volume indicated. The cooking of the next chicken batch may proceed in the manner previously indicated, whereupon the cooking oil is again filtered and replenished for cooking of a like number of chicken batches.

In conventional cookers, when the filter tank accumulates sufficient quantity of food particles, or at the end of a day of operation, the door of the cabinet is opened, and the valve is opened to drain all of the remaining liquid from the vessel into a suitable container. The cooked food particles which have accumulated will be found to be unburned and suitable for further use as desired, for example as a favorable ingredient for making gravy.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented herein above. Rather, what is intended to be covered is within the spirit and scope of the appended claims.

What is claimed is:

1. A cooking apparatus comprising an open-top pressure vessel having a bottom connecting to a side wall and adapted to contain a replaceable batch of cooking liquid, means disposed within said vessel for rapidly heating said liquid by direct contact therewith, a sealable cover for said vessel mounted adjacent an upper portion of the vessel with a removable collector unit attached to a lower portion of said wall, said unit being adapted to retain loose food particles dropping from said vessel and to contain a relatively cool and quiescent portion of said liquid, selectively operable drainage means for draining and filtering said cooking liquid from said vessel after each cook and replenishing used oil from a reservoir, a perforated basket insertable into said vessel for holding food to be cooked, at least one capacitor sensor attached to or disposed in said side wall in contact with the cooking liquid for sensing the level of the liquid contained within said vessel, means for detecting the temperature of said cooking liquid, means for automatically releasing vapor from said vessel when a predetermined vapor pressure is reached therein, and a programmable logic controller or microprocessor for interface with a user operator in electrical communication said capacitor sensors and means for controlling the level and flow rate and a relay for controlling temperature of the cooking oil in electrical communication with said at least one capacitor.

2. Apparatus as defined in claim 1 including a tubular perforated sleeve removably disposed within said vessel between the basket and the vessel wall.

3. Apparatus as defined in claim 2 wherein said heating means comprises an electrical resistor disposed between the vessel wall and said sleeve, the presence of said sleeve aiding in establishing an upwardly directed convection current of hot liquid in the space between said sleeve and said wall.

4. Apparatus as defined in claim 1, including a plurality of capacitor sensors is disposed around an inner wall of said vessel at selected positions to detect the level of oil in the vessel.

5. Apparatus as defined in claim 1 wherein said collector unit is detachably locked upon said lower portion of said vessel wall and is removable downwardly following the draining of liquid from said vessel and from said unit.

6. Apparatus as defined in claim 1 wherein said drainage means includes a drain pipe extending laterally from the wall of said collector unit at a location adjacent the upper end of said unit, and a valve disposed in said pipe, said pipe being adapted to drain the liquid from said vessel and from the upper portion of said collector unit when said valve is in open position.

7. A cooking apparatus comprising an open-top vessel having a bottom connecting to a side wall and adapted to contain a replaceable batch of cooking liquid, means disposed within said vessel for rapidly heating said liquid by direct contact therewith, a removable collector unit attached to a lower portion of said wall, selectively operable drainage means for draining and filtering said cooking liquid from said vessel after each cook and replenishing used oil from a reservoir, a perforated basket insertable into said vessel for holding food to be cooked, at least one capacitor sensor attached to or disposed in said side wall in contact with the cooking liquid for sensing the level of the liquid contained within said vessel, means for detecting the temperature of said cooking liquid, and a programmable logic controller or computer for interface with a user operator in electrical communication said capacitor sensors and means for controlling the level and flow rate and temperature of the cooking oil.

8. Apparatus as defined in claim 7 including a tubular perforated sleeve removably disposed within said vessel between the basket and the vessel wall.

9. Apparatus as defined in claim 8 wherein said heating means comprises an electrical resistor disposed between the vessel wall and said sleeve, the presence of said sleeve aiding in establishing an upwardly directed convection current of hot liquid in the space between said sleeve and said wall.

10. Apparatus as defined in claim 7, including a plurality of capacitor sensors is disposed around an inner wall of said vessel at selected positions to detect the level of oil in the vessel.

11. Apparatus as defined in claim 7 wherein said collector unit is detachably locked upon said lower portion of said vessel wall and is removable downwardly following the draining of liquid from said vessel and from said unit.

12. Apparatus as defined in claim 7 wherein said drainage means includes a drain pipe extending laterally from the wall of said collector unit at a location adjacent the upper end of said unit, and a valve disposed in said pipe, said pipe being adapted to drain the liquid from said vessel and from the upper portion of said collector unit when said valve is in open position.

13. Apparatus as defined in claim 7 including a sealable cover for said vessel mounted adjacent to an upper portion of the vessel.
